(19) United States
(12) Patent Application Publication
(10) Pub. No.: US 2014/0010360 A1
(43) Pub. Date: Jan. 9, 2014

(54) CALL MANAGEMENT APPARATUS, CALL MANAGEMENT METHOD, AND RECORDING MEDIUM

(71) Applicant: Fujitsu Limited, Kawasaki-shi (JP)

(72) Inventors: Naoto KAWASHIMA, Yokohama (JP); Naoto MATSUDAIRA, Yokohama (JP); Yuusuke TOUNAI, Nishi (JP); Hiroshi YOSHIDA, Yokohama (JP); Shingo HIRONO, Yokohama (JP)

(73) Assignee: Fujitsu Limited, Kawasaki-shi (JP)

(21) Appl. No.: 14/018,182

(22) Filed: Sep. 4, 2013

Related U.S. Application Data
(63) Continuation of application No. PCT/JP2011/056456, filed on Mar. 17, 2011.

(51) Int. Cl. H04M 3/51

(52) U.S. Cl. CPC H04M 3/5175
USPC 379/265.03

(57) ABSTRACT

A call management apparatus includes a storage storing a questioner identifier in association with a reference data identifier for a call performed between a questioner and an operator who responds to the questioner, the questioner identifier identifying the questioner and the reference data identifier identifying reference data that are displayed on an operator terminal used by the operator during the call and that are used when the operator responds to the questioner; an identification unit referring to the storage, identifying the questioner identifier and the reference data identifier that are associated with a first call, and identifying a second call that is different from the first call and associated with the same questioner identifier and the same reference data identifier associated with the first call; and an output unit outputting first data related to the first call and second data related to the second call.

### CROSS-REFERENCE TO RELATED APPLICATION

This application is a continuation application of International Application PCT/JP2011/056456 filed on Mar. 17, 2011 and designated the U.S., the entire contents of which are incorporated herein by reference.

### FIELD

The embodiment discussed herein is related to a call management apparatus, a call management method, and a recording medium.

### BACKGROUND

More and more importance is being placed on quality improvement of conversation contents in a call center. For evaluating such quality, there have been known a technique in which a ratio between the time period when an operator and a questioner speak simultaneously and the total time period is calculated (see, for example, Japanese Laid-open Patent Publication No. 2007-288242), and a technique in which the conversation time is compared with the average conversation time (see, for example, Japanese Laid-open Patent Publication No. 2005-258551).

### SUMMARY

According to an aspect of this disclosure, a call management apparatus includes a storage storing a questioner identifier in association with a reference data identifier for a call performed between a questioner and an operator who responds to the questioner, the questioner identifier identifying the questioner and the reference data identifier identifying reference data that are displayed on an operator terminal used by the operator during the call and that are used when the operator responds to the questioner; an identification unit referring to the storage, identifying the questioner identifier and the reference data identifier that are associated with a first call, and identifying a second call that is different from the first call and associated with the same questioner identifier and the same reference data identifier associated with the first call; and an output unit outputting first data related to the first call and second data related to the second call.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a drawing illustrating an example configuration of a call-center support system according an embodiment of the present invention;

FIG. 2 is a drawing illustrating an example hardware configuration of a call management apparatus according to an embodiment of the present invention;

FIG. 3 is a drawing illustrating an example functional block diagram of the call management apparatus according to an embodiment of the present invention;

FIG. 4 is a drawing illustrating an example functional block diagram of an operator terminal according to an embodiment of the present invention;

FIG. 5 is a drawing illustrating an example functional block diagram of a manager terminal according to an embodiment of the present invention;

FIG. 6 is a flowchart illustrating an example procedure executed by a call management apparatus when a call is received and during the call;

FIG. 7 is a drawing illustrating an example configuration of an operator data storage;

FIG. 8 is a drawing illustrating an example configuration of a response history storage;

FIG. 9 is a drawing illustrating an example configuration of a manual data storage;

FIG. 10 is a drawing illustrating an example configuration of a reference history storage;

FIG. 11 is a drawing illustrating an example configuration of an evaluation data storage;

FIG. 12 is a flowchart illustrating an example procedure of a recording of call data;

FIG. 13 is a drawing illustrating an example configuration of a voice data management table included in a voice data storage; Management table included in a voice data storage;

FIG. 14 is a flowchart illustrating an example procedure of checking an utterance state of an operator;

FIG. 15 is a drawing illustrating an example configuration of an utterance history table included in an utterance history storage,

FIG. 16 is a flowchart illustrating an example procedure of checking an utterance state of a questioner;

FIG. 17 is a flowchart illustrating an example procedure of updating an evaluation value;

FIG. 18 is a drawing illustrating an example display of an utterance history screen;

FIG. 19 is a drawing illustrating an example configuration of a relevant condition storage;

FIG. 20 is a drawing illustrating an example of relevant utterance history;

FIG. 21 is a drawing illustrating an example display of a pop-up screen displaying the relevant utterance history; and

FIG. 22 is a drawing illustrating an example display of an utterance history screen on which a re-evaluation value is reflected.

### DESCRIPTION OF EMBODIMENT

With the related art technologies described above, the evaluation results are obtained based only on respective conversations. Therefore, it is difficult to obtain appropriate evaluation results taking into account a case where, for example, a questioner, who could not understand an operator's explanation, makes another phone call to the call center.

For example, there may be a case as described below. An operator “A” answers an initial question from a questioner “X”. However, the questioner “X” cannot fully understand the explanation by the operator “A”. The questioner “X” hangs up the call and tries to understand the explanation by the operator “A”, but cannot understand after all. Then, the questioner “X” makes another phone call to the call center.

In such a case, it is to be understood that there is a problem in the first response by the operator “A”. However, with the related art technologies, it is difficult to determine that the problem lies in the operator “A”. Here, when another operator “B” answers the same question from the questioner “X” realizing that this is the second response (explanation) for the questioner “X”, the operator “B” may spend time greater than the average conversation (explanation) time to more elaborately answer the question.

According to the evaluation based on the related art technologies, the evaluation of the operator “B” may be low because of the conversation (explanation) time period longer than the average time period.

Therefore, to appropriately evaluate the response by the operator, it is desired to consider the relationships among a plurality of call (conversation) responses.

Here, when a relationship among call responses is determined based only on a fact that the call responses are related to the same client, the call responses having no relationship with each other may be determined to be related to each other.

Further, even if relationships among a plurality of call responses are appropriately determined, it may also be desired to provide information indicating which part of a call response is related to which part of another call response, so that it becomes easier for an evaluator (estimator) to identify those related parts. If such information is not provided, the evaluator may have to sequentially listen from the beginning of each call response record, which is typically recorded as an audio (voice) file, which may become a heavy workload for the evaluator.

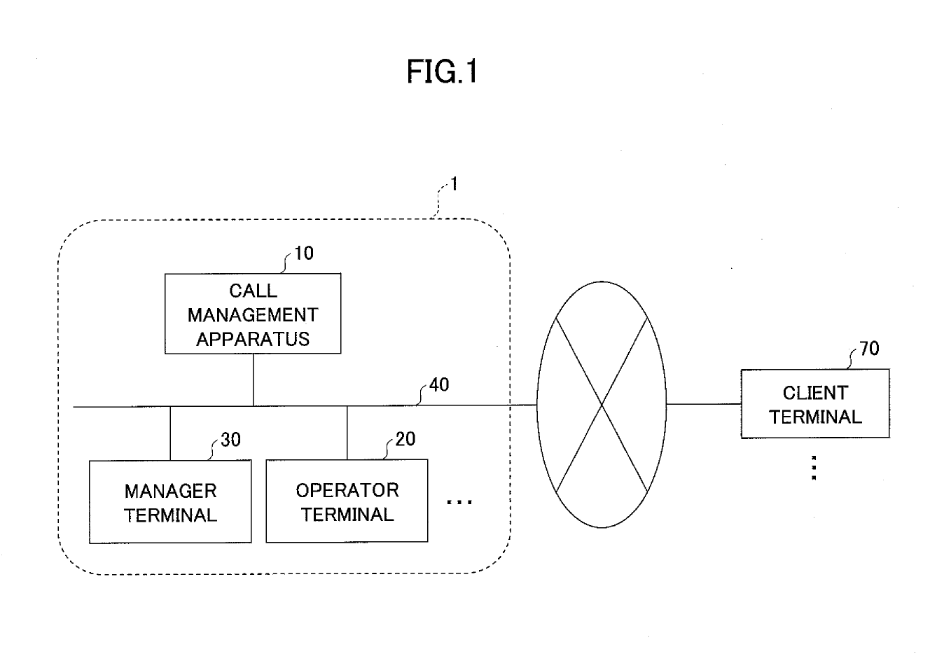

In the following, an embodiment of the present invention is described with reference to the accompanying drawings. FIG. 1 illustrates an example configuration of a call-center support system according an embodiment. A call-center support system 1 of FIG. 1 is a computer system to support the operations of the call center. As illustrated in FIG. 1, the call-center support system 1 includes a call management apparatus 10, a plurality of operator terminals 20, a manager terminal 30 and the like.

The call management apparatus 10 is a computer having an Automatic Call Distributor (ACD) function. For example, the call management apparatus 10 automatically distributes a call from a telephone outside the call center (i.e., a client terminal 70 in FIG. 1) to one operator terminal 20. Here, the client terminal 70 is not limited to any specific apparatus and may be an apparatus having a calling function such as a landline phone or a cellular phone.

The operator terminal 20 is a computer used by an operator who responds to a call. The operator terminal 20 may include a head set connected to the operator terminal 20 so as to provide the calling function.

The manager terminal 30 is a computer used by a manager or an administrator who may generally be called a supervisor.

Further, the call management apparatus 10, the operator terminals 20, and the manager terminal 30 are mutually in communication with each other via a (wire or wireless) network 40 such as a Local Area Network (LAN). The call received by the call management apparatus 10 is digitized outside the call management apparatus 10. The telephone calls related to the calls distributed to the respective operator terminals 20 are transmitted via the network 40 in the call-center support system 1.

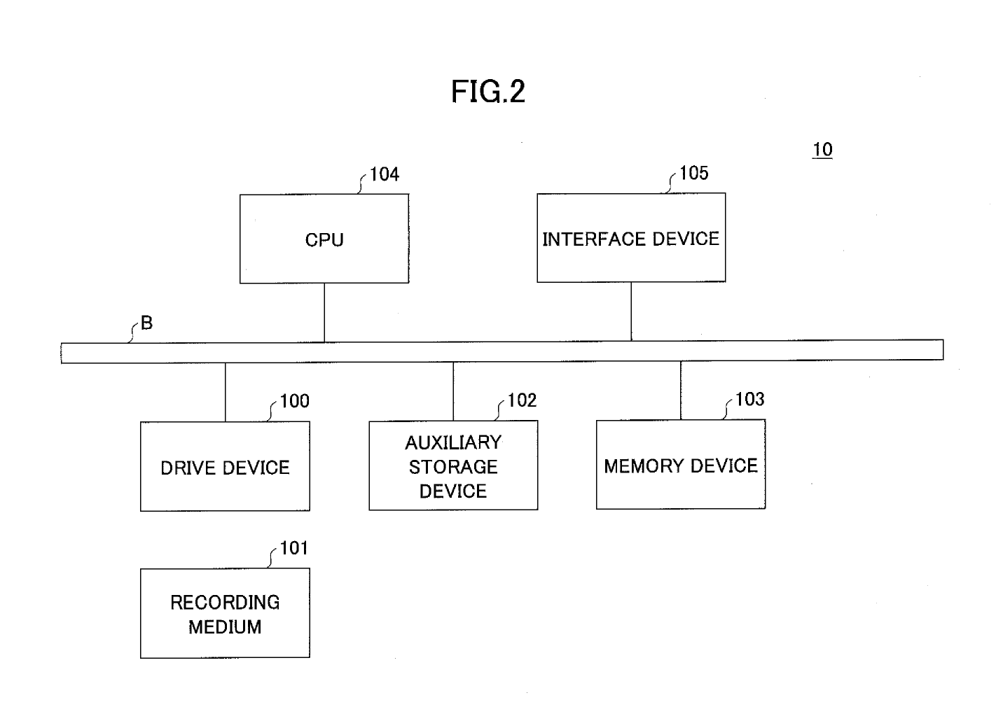

FIG. 2 illustrates an example hardware configuration of the call management apparatus 10 according to an embodiment. As illustrated in FIG. 2, the call management apparatus 10 includes a drive device 100, an auxiliary storage device 102, a memory device 103, a Central Processing Unit (CPU) 104, and an interface device 105.

A program that realizes a process to be executed by the call management apparatus 10 is provided using a recording medium 101. When the recording medium 101 storing the program is set in the drive device 100, the program in the recording medium 101 is installed in the auxiliary storage device 102.

However, the installation of the program is not limited to using the recording medium 101. Alternatively, the program may be downloaded from another computer via a network. Further, the auxiliary storage device 102 stores not only the program but also necessary files, data and the like.

When an instruction to start the program is issued, the program in the auxiliary storage device 102 is loaded and stored into the memory device 103. The CPU 104 executes (controls) the functions of the call management apparatus 10 based on the program stored in the memory device 103. The interface device 105 is used as an interface to the network.

Further, the recording medium 101 may be, for example, a portable recording medium such as a CD-ROM, a DVD disk, a USB memory or the like. Further, the auxiliary storage device 102 may be, for example, a Hard Disk Drive (HDD), a flash memory or the like. Each of the recording medium 101 and the auxiliary storage device 102 corresponds to a computer-readable recording medium.

The operator terminal 20 and the manager terminal 30 may have a hardware configuration similar to that of the call management apparatus 10. However, it is preferable that each of the operator terminal 20 and the manager terminal 30 includes a display device such as a liquid crystal display, an input device such as a keyboard, a mouse and the like.

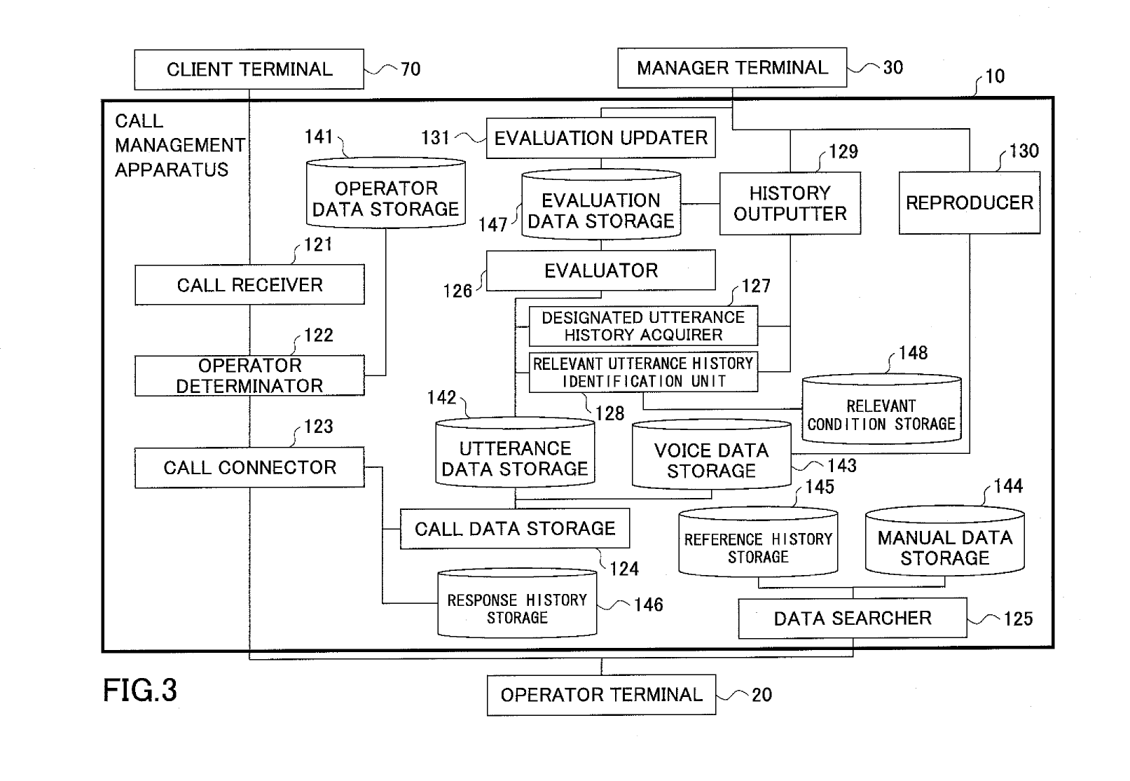

FIG. 3 illustrates an example functional block diagram of the call management apparatus 10 according to an embodiment. As illustrated in FIG. 3, the call management apparatus 10 includes a call receiver 121, an operator determinator 122, a call connector 123, a call data storage 124, a data searcher 125, an evaluator 126, a designated utterance history acquirer 127, a relevant utterance history identification unit 128, a history output unit 129, a reproducer 130, and an evaluation updater 131. Those elements may be realized by the processes which are executed by the CPU 104 in accordance with one or more programs installed in the call management apparatus 10.

The call management apparatus 10 further includes an operator data storage 141, an utterance data storage 142, a voice data storage 143, a manual data storage 144, a reference history storage 145, a response history storage 146, an evaluation data storage 147, and a relevant condition storage 148. Those storages may be realized (provided) by using the auxiliary storage device 102. Otherwise, those storages may be realized by using a storage device connected to the call management apparatus 10 via a network.

The call receiver 121 receives a call from outside (e.g., the client terminal 70 in this embodiment). The operator determinator 122 determines an operator who is in charge of the response to the received call by referring to the operator data storage 141 and the like. The operator data storage 141 stores attribute data for each of the operators. The attribute data includes data indicating the current state of the operators (i.e., whether each of the operators is on the phone or waiting for a call).

The call connector 123 connects the received call to the operator terminal 20 of the operator determined by the operator determinator 122. The call data storage 124 records, for example, voice data indicating the call contents, history of the utterance time period of each of the operator and the client (hereinafter simplified as “utterance history”) and the like. The utterance history is stored in the utterance data storage 142, and the voice data and data related to the voice data are stored in the voice data storage 143.

The data searcher 125 responds to an acquisition request (search request) to acquire a manual (electronic manual) from the operator terminal 20 of the operator who is on the phone (talking with a client over the phone) acquires a manual, and acquires the manual designated by the acquisition request by referring to the manual data storage 144.

The data searcher 125 transmits the acquired manual to the operator terminal 20. The manual data storage 144 stores a file name of the file where the manual is stored for each manual and for each page of the manual. The data searcher 125 records (stores) the history of referring to the manual (reference history of the manual) into the reference history storage 145.

The evaluator 126 records an evaluation value (score) of each of the telephone calls (calls, or telephone conversations) in the evaluator 126 based on, for example, the utterance history stored in the utterance data storage 142. The designated utterance history acquirer 127 acquires the utterance history related to a specific call designated by the manager terminal 30.

The relevant utterance history identification unit 128 identifies the utterance history having a relationship with the utterance history which is acquired by the designated utterance history acquirer 127, the relationship being determined (satisfied) based on a predetermined condition. The relevant condition storage 148 stores the predetermined condition (hereinafter “relevant condition”). The relevant condition herein refers to a condition estimating that the call relates to the same question from the same questioner (client).

The history output unit 129 transmits the utterance history acquired by the designated utterance history acquirer 127 or the utterance history identified by the relevant utterance history identification unit 128 to the manager terminal 30. The reproducer 130 reproduces the voice of the voice data related to the call designated by the manager terminal 30. The evaluation updater 131 updates the evaluation value of the call designated by the manager terminal 30.

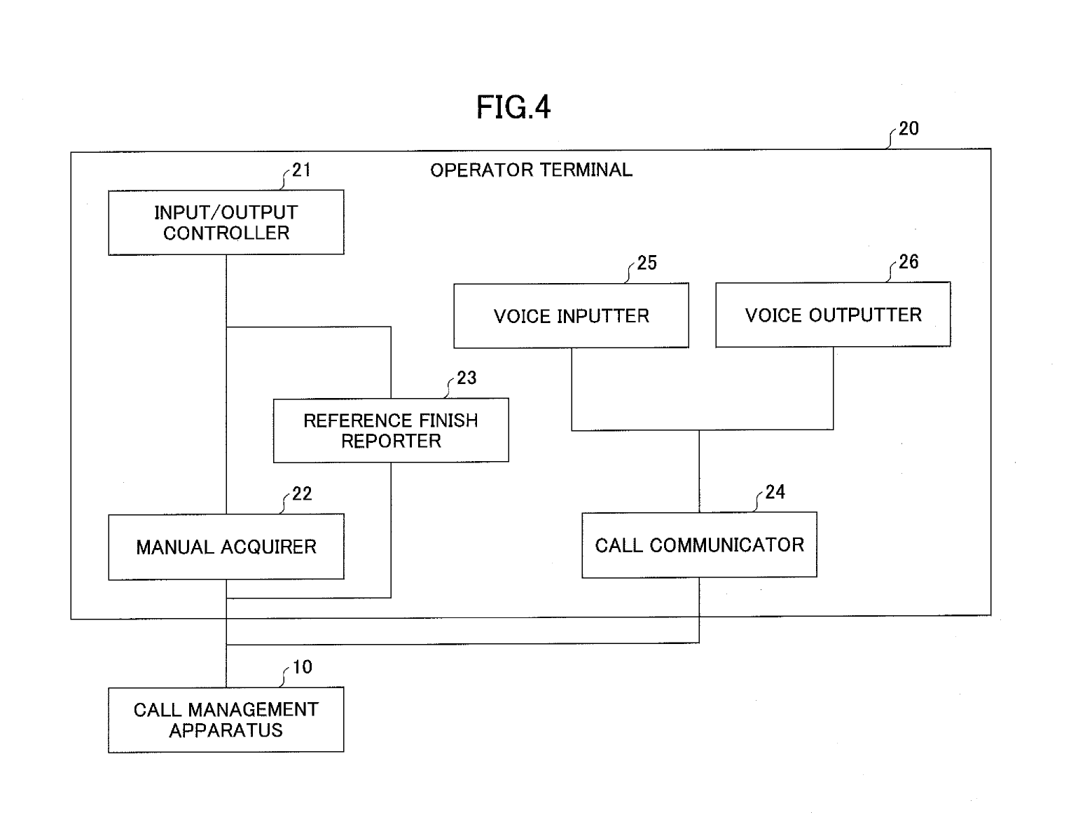

FIG. 4 illustrates an example functional block diagram of the operator terminal 20 according to an embodiment. As illustrated in FIG. 4, the operator terminal 20 includes an input/output controller 21, a manual acquirer 22, a reference finish reporter 23, a call communicator 24, a voice input unit 25, and a voice output unit 26. Those elements may be realized by the processes which are executed by the CPU of the operator terminal 20 in accordance with one or more programs installed in the operator terminal 20.

The input/output controller 21 performs a process in accordance with an input via a keyboard, mouse or the like, and controls, for example, an output process of a display device. The manual acquirer 22 acquires the manual designated by an operator from the call management apparatus 10.

The reference finish reporter 23 reports the end of referring to the manual to the call management apparatus 10. The call communicator 24 controls the communication related to a call. The voice input unit 25 receives an input of the utterance by an operator. The voice output unit 26 outputs the utterance by the client.

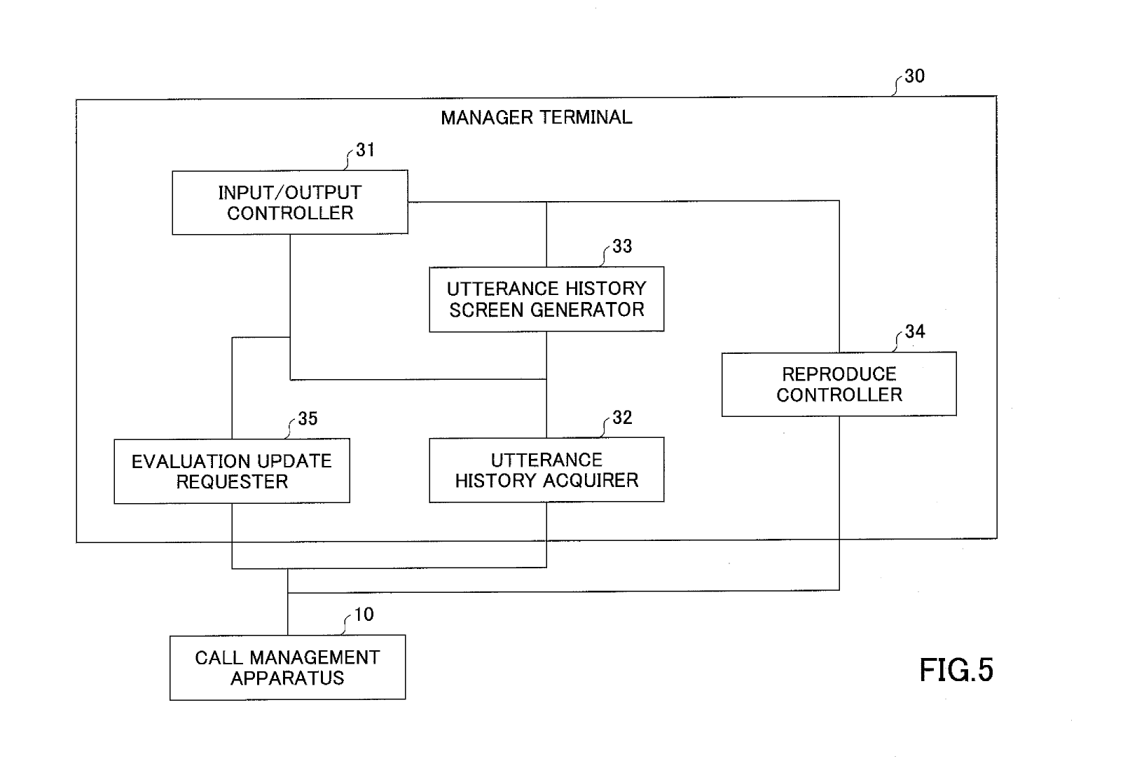

FIG. 5 illustrates an example functional block diagram of the manager terminal 31 according to an embodiment. As illustrated in FIG. 5, the manager terminal 30 includes an input/output controller 31, an utterance history acquirer 32, an utterance history screen generator 33, a reproduce controller 34, and an evaluation update requester 35. Those elements may be realized by the processes which are executed by the CPU of the manager terminal 30 in accordance with one or more programs installed in the manager terminal 30.

The input/output controller 31 performs a process in accordance with an input via the keyboard, the mouse or the like, and controls an output process of the display device. From the call management apparatus 10, the utterance history acquirer 32 acquires, for example, the utterance history related to a call designated by the manager and the utterance history having a relationship with the utterance history related to the call, the relationship being determined (satisfied) based on the relevant condition.

The utterance history screen generator 33 generates a screen to display the utterance history acquired by the utterance history acquirer 32. The reproduce controller 34 controls the reproduction of the call contents related to the utterance history displayed on the generated screen. The evaluation update requester 35 sends a request to the call management apparatus 10 for updating the evaluation value of the call related to the utterance history displayed on the generated screen.

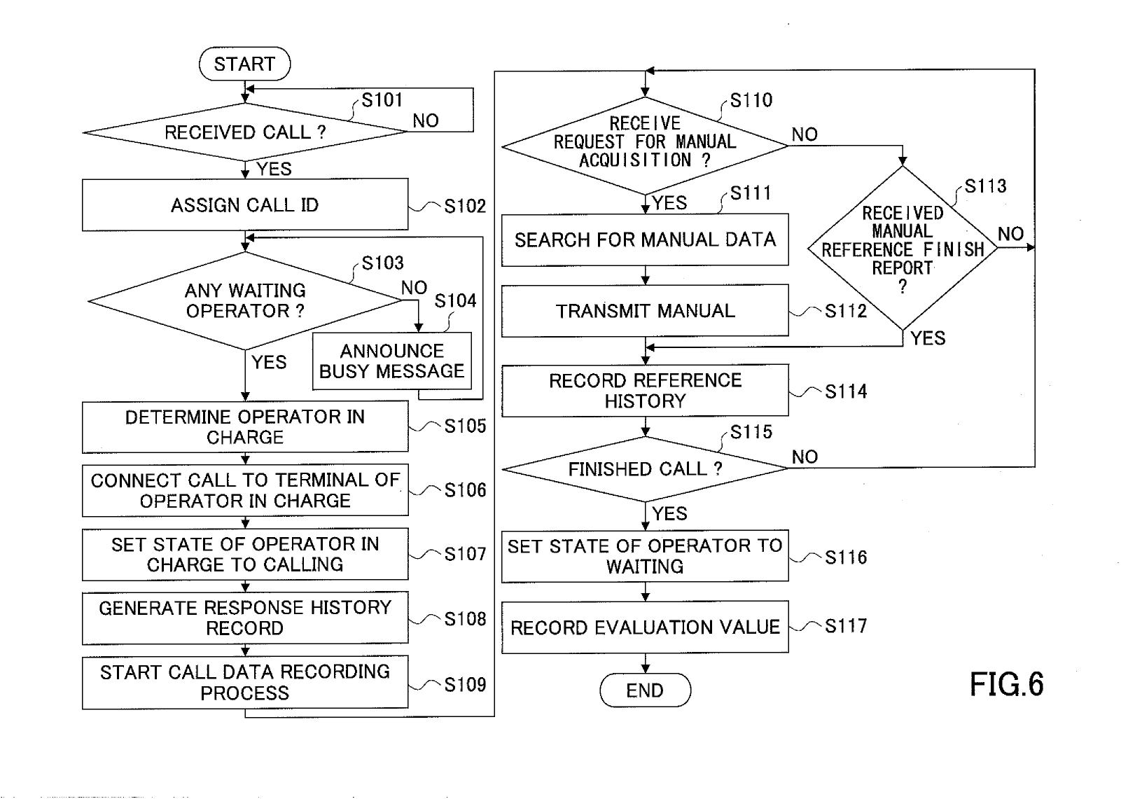

In the following, a procedure executed by the call management apparatus 10 is described. FIG. 6 is a flowchart illustrating an example procedure executed by the call management apparatus when a call is received and during the call.

Upon receiving a call initiated by the client terminal 70 (Yes in step S101), the call receiver 121 allocates a call ID to the call (step S102). The call ID is an identifier to identify the call (i.e. the telephone call). Then, the operator determinator 122 refers to the operator data storage 141 and determines whether there is an operator who is waiting for a call (i.e., an operator who is not on the phone) (step S103).

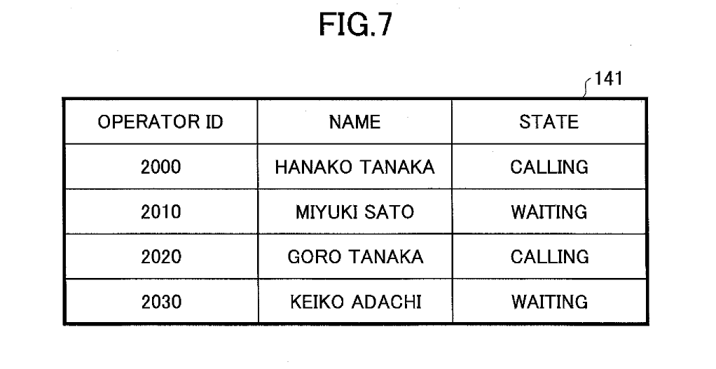

FIG. 7 illustrates an example configuration of the operator data storage 141. As illustrated in FIG. 7, the operator data storage 141 stores (includes) items indicating an “operator ID”, “name”, and “state” for each operator.

Here, the “operator ID” refers to an identifier to identify the operator. The “name” refers to the operator's name. The “state” refers to the current operator's state. In FIG. 7, as the values of the “state”, the “calling” and “waiting” are indicated. The “calling” means that the operator is on the phone (responding to a client).

The “waiting” means that the operator is able to be allocated (assigned) to respond to a call.

In step S103, the operator determinator 122 searches for (identifies) an operator having a state of “waiting” from the operator data storage 141.

When no “waiting” operator is identified (No in step S103), the operator determinator 122 may reproduces a voice message saying, for example, that “all lines are busy now” until an appropriate (available) operator is identified (step S104).

When one or more appropriate operators are identified (Yes in step S103), the operator determinator 122 determines one of the identified operators as an operator who is to be assigned to the call (hereinafter “operator in charge”) (step S105).

Next, the call connector 123 connects (or distributes) the call to the operator terminal 20 of the operator in charge (step S106). Then, the call connector 123 updates the value of the “state” of the operator in charge in the operator data storage 141 to “calling” (step S107). Then, the call connector 123 generates a record corresponding to the received call in the response history storage 146 (step S108).

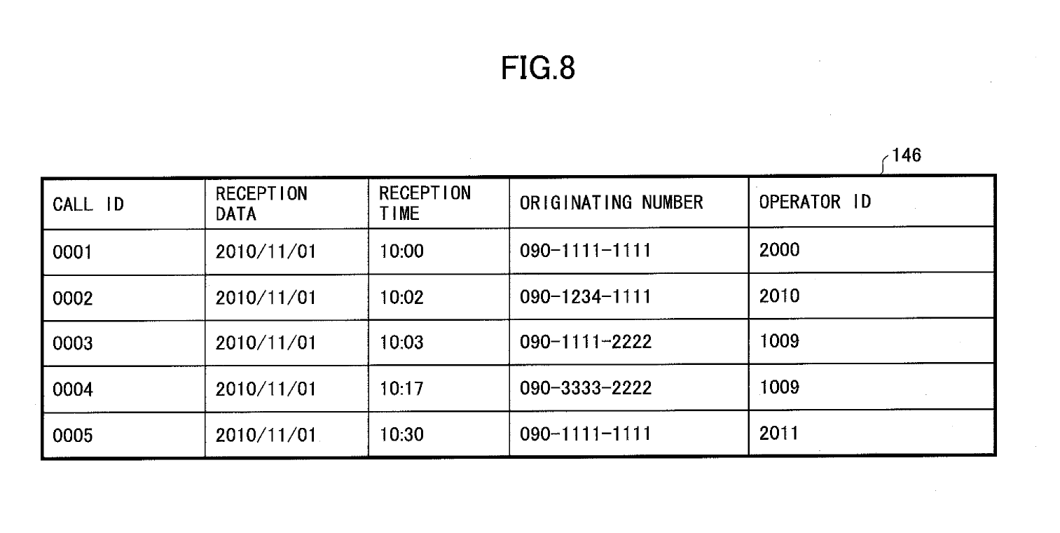

FIG. 8 illustrates an example configuration of the response history storage 146. As illustrated in FIG. 8, the response history storage 146 stores (includes) items indicating a “call ID”, “reception date”, “reception time”, “originating number”, and “operator ID” for each response by the operator (i.e., for each call or telephone call (conversation)).

The “call ID” corresponds to a call related to the response. The “reception date” refers to the date when the call is received. The “reception time” refers to the time when the call is received. The “originating number” refers to the telephone number of the originator (client). The “operator ID” refers to the ID of the operator who is in charge of the response to the call.

In step S108, the call connector 123 generates a new record in the response history storage 146, and records (inputs) the values of the “call ID”, “reception date”, “reception time”, “originating number”, and “operator ID” of the generated record. Here, a call ID assigned to this call is recorded in the “call ID”. The date and time when this call is received are recorded in the “reception date” and “reception time”, respectively. The originating telephone number of this call is recording in the “originating number”. The operator ID of the operator in charge of this call is recorded in the “operator ID”.

Next, the call data storage 124 starts a recording process of recording the call data (step S109). In the recording process of recording the call data, the voice data of the call contents are recorded, and the data indicating the time data of the utterance of the operator in charge and the time data of the utterance of the questioner (“call data”) are also recorded. More details of the recording process of recording the call data are described below.

When the process of step S109 ends, telephone conversations starts between the operator in charge and the questioner by asking and answering questions. In answering the question by the operator in charge, when it is necessary to refer to a manual, the operator in charge may, for example, designate (input) the manual name and the page number of the manual in the operator terminal 20 to display the designated page of the manual. The manual acquirer 22 of the operator terminal 20 designates the operator ID, the manual name, and the page number and sends a request for acquiring the page of the manual to the call management apparatus 10.

Further, to designate the manual name and the page number, the operator may input the corresponding character strings or select the manual name and the page number based on a screen displaying a list of the manuals and a list of the indexes of the manuals.

Next, upon receiving the request for acquiring the page of the manual from the operator terminal 20 (Yes on step S110), the data searcher 125 searches for the manual data corresponding to the manual name and the page number designated in the acquisition request from the manual data storage 144 (step S111).

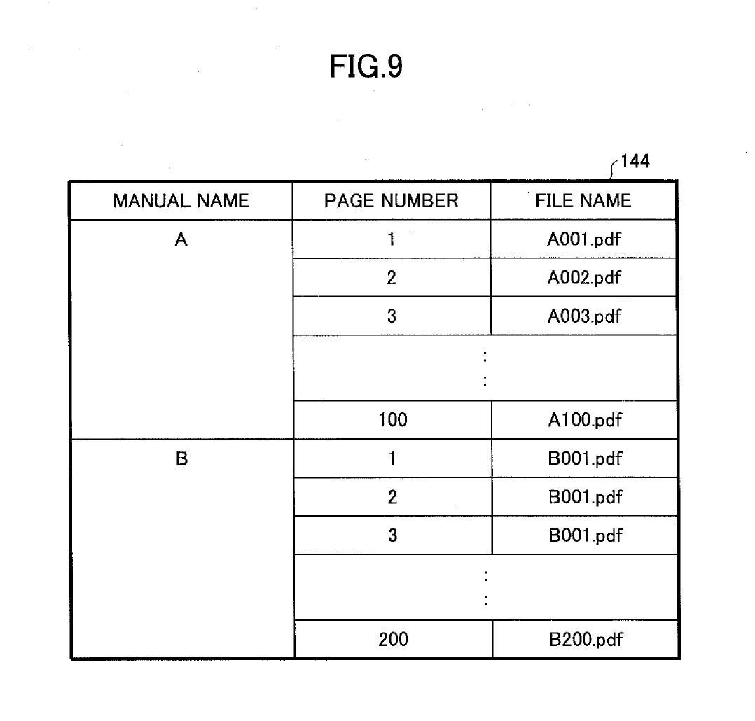

FIG. 9 illustrates an example configuration of the manual data storage 144. As illustrated in FIG. 9, the manual data storage 144 stores the manual data including items indicating a “manual name”, “page number”, and “file name” for each of the pages of the manuals.

The “manual name” refers to a name of the manual, the “page number” refers to the page number of the manual, and the “file name” refers to a name of the file storing the contents of the page of the manual identified by (a combination of) the manual name and the page number.

In step S111, the data searcher 125 acquires the file of the file name corresponding to the manual name and the page number designated in the request for acquiring the manual. Further, in the embodiment, a case is described where the file is provided for each of the pages of the manuals. However, the file may be provided for each of sections such as the chapters or sectors in the manual.

In this case, the manager does not designate the page number but designates the chapter, section or the like. Further, the manual data storage 144 stores the file names in accordance with the data indicating the chapter, section or the like.

Next, the data searcher 125 transmits the page of the manual stored in the acquired file to the operator terminal 20 which is the source of sending the request for acquiring the file (step S112). In the operator terminal 20, when the page of the manual is received by the manual acquirer 22, the input/output controller 21 causes the display device of the operator terminal 20 to display the page of the manual. As a result, the operator may answer the question while referring to the page of the manual.

Next, the data searcher 125 records a history in the reference history storage 145, the history indicating that the page of the manual transmitted in step S112 has been referred to (step S114).

On the other hand, in the operator terminal 20 where the page of the manual is displayed, when the reference to the page of the manual is finished, the reference finish reporter 23 of the operator terminal 20 transmits a report of finishing the reference of the page of the manual to the call management apparatus 10.

In this report, for example, the operator ID is designated. Further, it is possible to determine that the reference of the page of the manual is finished by, for example, detecting that the screen (or window) displaying the page of the manual is no longer displayed (closed).

Upon receiving the report of finishing the reference of the page of the manual (Yes in step S113), the data searcher 125 of the call management apparatus 10 records the history in the reference history storage 145, the history indicating that the reference of the page of the manual is finished (step S114).

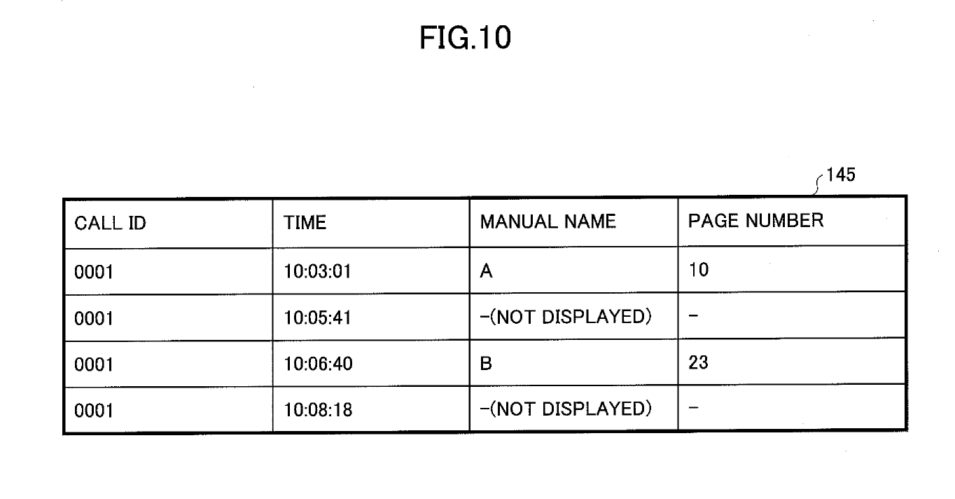

FIG. 10 illustrates an example configuration of the reference history storage. As illustrated in FIG. 10, the reference history storage 145 stores (includes) items indicating a “call ID”, “time”, “manual name”, and “page number” for each of the starting or finishing referring to the page of the manual.

The “call ID” refers to an ID to identify the telephone call (call) in which the page of the manual is referred to. The “time” refers to the start time or end time of referring to the page of the manual. The “manual name” and “page number” are the name of the manual and the page number of the manual and page that are referred to.

In step S114 when the request for acquiring the page of the manual is received (acquisition request), a recording including the call ID corresponding to the operator ID designated in the acquisition request, the current time, and the record including the manual name and the page number designated in the acquisition request are added in the reference history storage 145.

On the other hand, in step S114 when the report of finishing the reference of the page of the manual is received, a recording including the call ID corresponding to the operator ID designated in the report of finishing the reference is added in the reference history storage 145. The call ID corresponding to the operator ID may be acquired by the response history storage 146 based on the record finally recorded related to the operator ID.

Further, it is possible to simultaneously refer to a plurality of pages of the manuals. Further, if it is possible to separately finish the pages of the manuals, the report of finishing the reference may include the corresponding manual name and the page number.

In this case, the manual name and the pager number may be recorded in the reference history storage 145. In this embodiment, a case is described where one manual page may be referred to. Therefore, when the reference of the manual page is finished, the manual name and the page number are not recorded in the reference history storage 145. In other words, by not recording the manual name and the page number, the finishing of referring the page of the manual is recorded in the reference history storage 145.

The process of steps S110 through S114 may be repeatedly executed during the “calling”. After that, when the call is finished (terminated) (Yes in step S115), the call connector 123 updates the value of the “state” of the operator in charge in the operator data storage 141 to “waiting” (step S116). The operator of the operator terminal 20 connected to the call may be identified based on the operator ID recorded for the call ID of the call in the response history storage 146.

Next, the evaluator 126 records the evaluation value of the quality of the finished call in the evaluation data storage 147 (step S117).

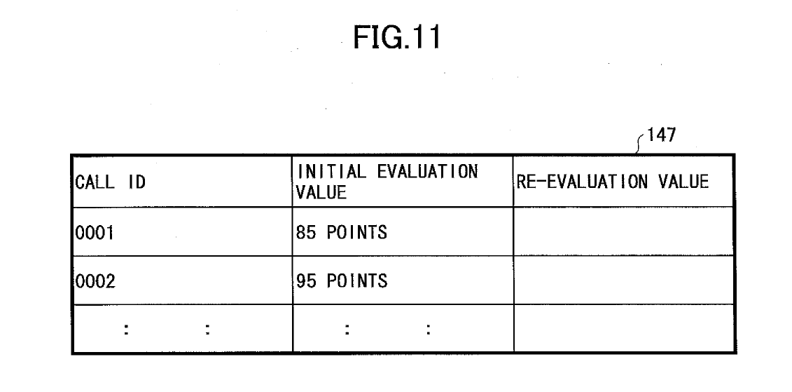

FIG. 11 illustrates an example configuration of the evaluation data storage. As illustrated in FIG. 11, the evaluation data storage 147 stores (includes) items indicating an “initial evaluation value” and “re-evaluation value” for each call ID (i.e., call or telephone call). The “initial evaluation value” refers to the value recorded in step S117. In this embodiment, a method of determining the “initial evaluation value” is not limited to a specific method.

For example, the “initial evaluation value” may be automatically calculated based on the utterance time period of the operator recorded in the recording process of the call data or the like. Otherwise, the manager may hear the recorded call contents and input the “initial evaluation value”. Further, it is not always desired that the recording of the “initial evaluation value” is executed in synchronization with the finishing of the call.

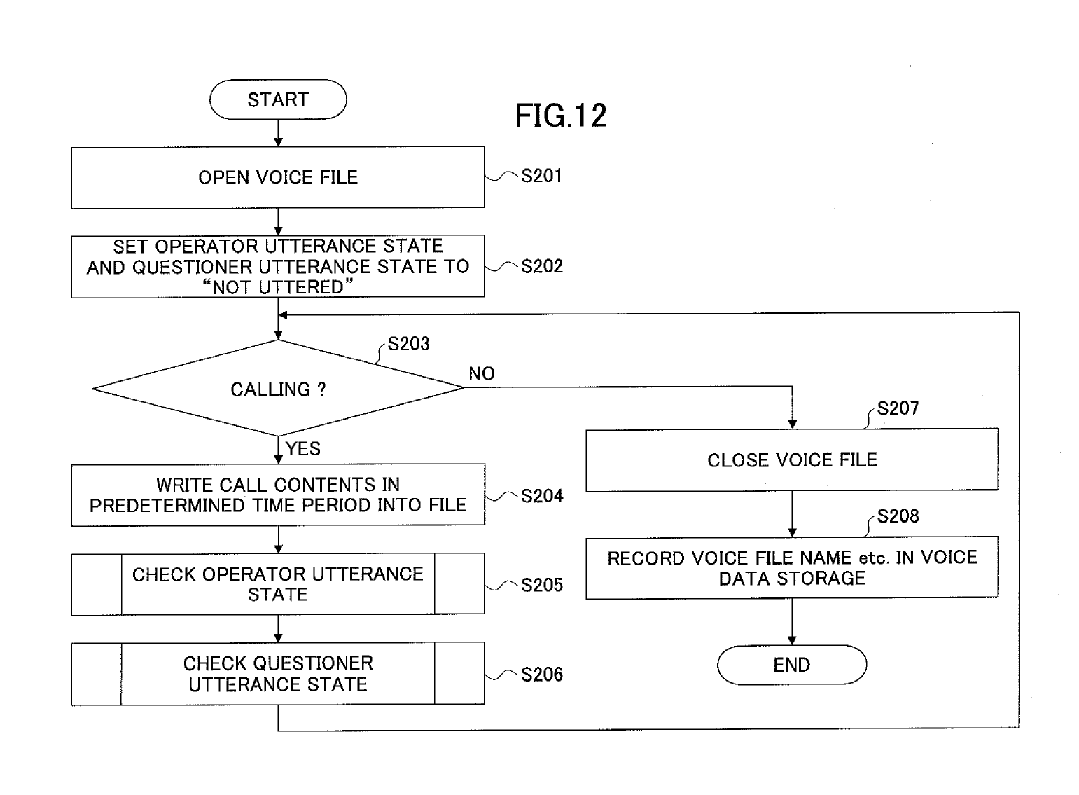

Next, a process of recording the call data, which starts in step S109 of FIG. 6, is described. FIG. 12 is a flowchart illustrating an example procedure of a recording of the call data. For example, the call data storage 124 may be initiated as a process for each call. In each of the processes, the call ID of the corresponding call (hereinafter “target call ID”) is designated.

In step S201, the call data storage 124 generates (opens) a voice file to record the call contents. The voice file may be generated in, for example, the voice data storage 143. Next, the call data storage 124 sets the values of the “operator utterance state” and the “questioner utterance state” to “not uttered” (step S202). The “operator utterance state” and the “questioner utterance state” are variables storing (indicating) the utterance state (speaking or not) of the operator in charge and the utterance state of the questioner, respectively, in the memory device 103 or the like.

Next, the call data storage 124 repeatedly executes the process of steps S204 through S206 during the “calling” (Yes in step S203).

In step S204, the call data storage 124 writes the call contents of a predetermined time period (e.g., 20 ms) in the voice file. Here, the term “call contents” refers to the voice data including both the utterance contents (voice) of the operator in charge and the utterance contents (voice) of the questioner. However, to distinguish the utterance contents of the operator in charge from the utterance contents of the questioner, those voices are recorded in stereo.

Next, the call data storage 124 performs a process to check the utterance state of the operator in charge (step S205). More specifically, the utterance start timing and the utterance finish timing of the operator in charge are detected, and when the utterance finish timing is detected, the utterance time period of the operator in charge is recorded.

Next, the call data storage 124 performs a process to check the utterance state of the questioner (step S206). Namely, the process, which is for checking the utterance state of the questioner, similar to the process in step S205 is performed.

Further, the processes of steps S205 and S206 may be done in just a moment. Therefore, during the “calling”, the process of steps S204 through S206 are repeated in the cycle substantially equal to a predetermined time interval spent in step S204 alone.

When the finish of the telephone call (cut of the call) is detected (No in step S203), the call data storage 124 closes the voice file (step S207). Next, the call data storage 124 records, for example, the file name of the voice file in the voice data storage 143 (step S208). After that, the process of the call data storage 124 corresponding to the target call ID is finished.

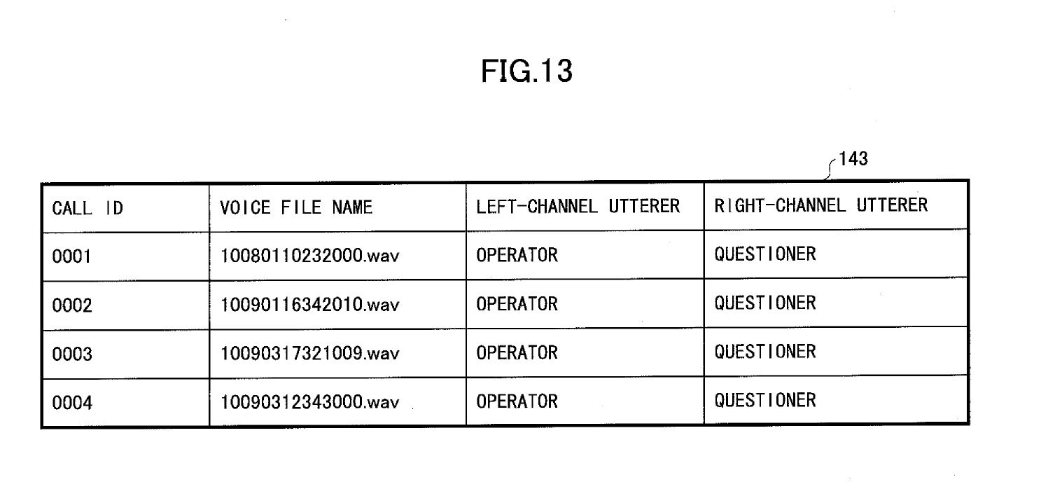

FIG. 13 illustrates an example configuration of a voice data management table included in the voice data storage. As illustrated in FIG. 13, a voice data management table 143T stores (includes) items indicating the “call ID”, “voice file name”, “left-channel utterer”, and “right-channel utterer” for each voice file in which the voice data of the recorded call contents are recorded.

The “call ID” refers to the call ID of the call related to the recorded telephone call. The “voice file name” refers to the file name of the voice file in which the voice data of the call contents are recorded. The “left-channel utterer” refers to the data indicating which of the operator or the questioner is the utterer of the voice recorded in left-channel of the voice data. The “right-channel utterer” refers to the data indicating which of the operator or the questioner is the utterer of the voice recorded in right-channel of the voice data.

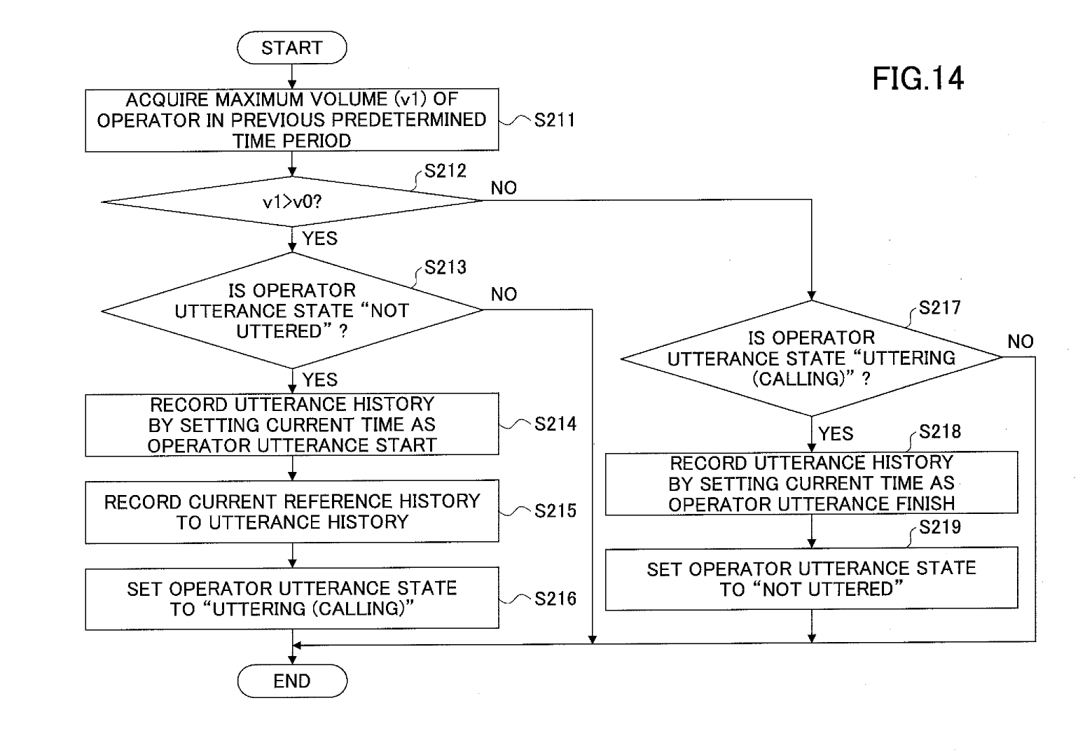

Next, details of the process in step S205 are described. FIG. 14 is a flowchart illustrating an example procedure of checking the utterance state of the operator.

In step S211, the call data storage 124 acquires the maximum volume of the voice of the operator (e.g. in the left-channel) in the previous predetermined time interval (in step S204). The maximum volume of the voice may be acquired based on an analysis of the voice file or measured during the predetermined time interval in step S204, and may be recorded in the memory device 103.

Next, the call data storage 124 determines whether the maximum volume of the voice of the operator in charge in the previous predetermined time interval is zero (step S212). Namely, it is determined whether there is the utterance of the operator in charge.

When determining that the maximum volume of the voice of the operator in charge in the previous predetermined time interval exceeds zero (Yes in step S212), the call data storage 124 further determines whether the utterance state of the operator in charge is “not uttered” (step S213).

When determining that the utterance state of the operator in charge is “not uttered” (Yes in step S213), the call data storage 124 records the current time in the utterance data storage 142 as the utterance start time of the operator in charge (step S214).

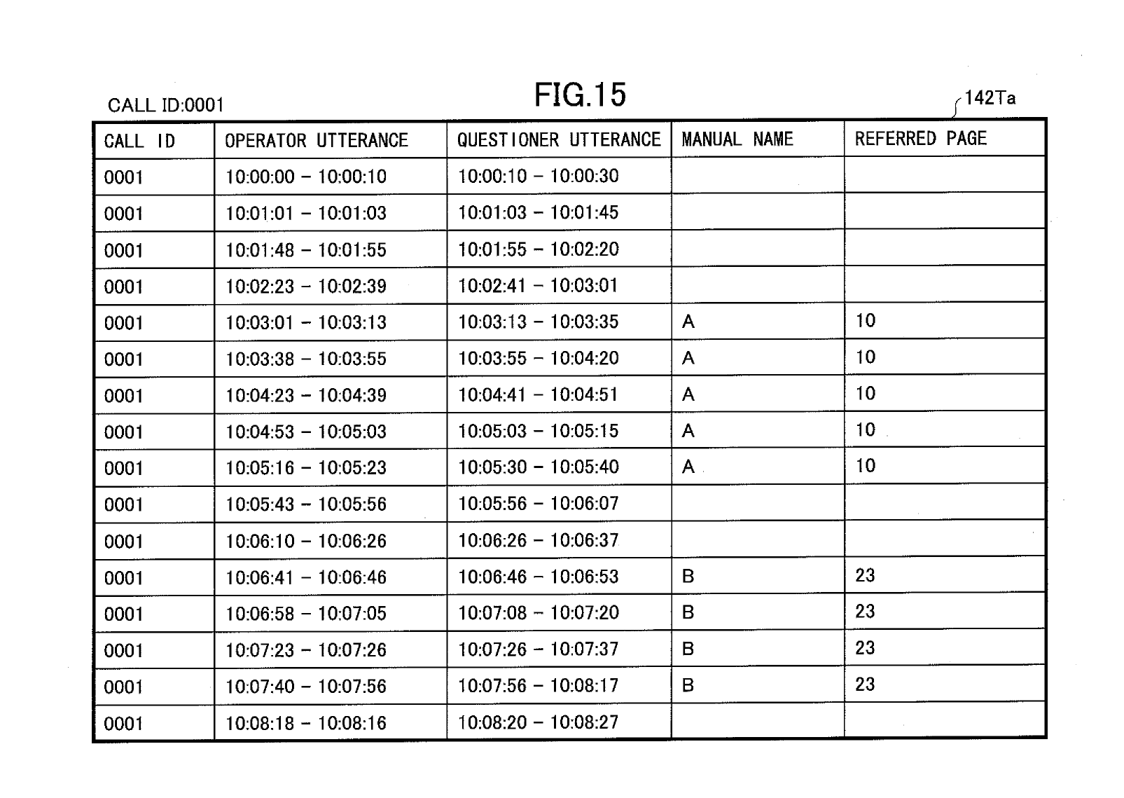

FIG. 15 illustrates an example configuration of an utterance history table included in the utterance history storage. As illustrated in FIG. 15, the utterance history table 142Ta stores (includes) the data indicating the time periods (start time and end time) when the utterance is done for each of the utterances by the operator (operator utterance) and the utterances by the questioner (questioner utterance).

Here, the term “utterance” refers to a unit which is stared when the utterance starts and finished when the utterance finishes. Typically, in a single telephone call, the operator in charge and the questioner exchange utterances with each other. Therefore, in a single call, a plurality of records are registered in the utterance history table 142Ta for each of the operator in charge and the questioner.

Further, when there is a time period in which a page of a manual is referred to, the utterance history table 142Ta records the identifier of the page of the manual (manual name and the page number) of the operator utterance corresponding to the time period. Further, the utterance history table 142Ta is generated for each of the calls (call IDs). For example, the utterance history table 142Ta of FIG. 15 corresponds to the call ID “0001”.

In step S214, a new record corresponding to the operator utterance is added in the utterance history table 142Ta, so that the current time is registered as the utterance start time of the record (hereinafter “current record”).

Next, when a manual page is referred to by the operator in charge at the current time point, the call data storage 124 records the identifier of the page of the manual (manual name and the page number) in the current record (step S215). Namely, the time period of the operator utterance is associated with the identifier of the page of the manual which is referred to.

Whether the page of the manual is referred to by the operator at the current time point may be determined based on whether the reference history storage 145 satisfies the following two conditions. The first condition is that in the reference history storage 145, the last record corresponding to the target call ID is the record indicating that the reference of the manual page is started.

The second condition is that the time of the record is later than the time when the call corresponding to the target call ID is received. In this embodiment, the record indicating that the reference of the manual page is started refers to the record in which the manual name and the page number are recorded.

Further, the association between the time period of the operator utterance and the identifier of the page of the manual which is referred to may not be performed in step S215. For example, the association may be performed by comparing the time periods of the operator utterance included in the utterance history table 142Ta corresponding to the target call IC with the time of the records corresponding to the target call ID in the reference history storage 145 when the telephone call is finished.

Next, the call data storage 124 updates the value (data) of the utterance state of the operator in charge to “uttering (calling)” (step S216).

On the other hand, when determining that the maximum volume of the voice of the operator in charge in the previous predetermined time interval is zero (No in step S212), the call data storage 124 further determines whether the utterance state of the operator in charge is “uttering (calling)” (step S217).

When determining that the utterance state of the operator in charge is “uttering (calling)” (Yes in step S217), the call data storage 124 records the current time in the utterance history table 142Ta corresponding to the target call ID as the utterance finish time of the operator in charge (step S218).

Next, the call data storage 124 updates the value (data) of the utterance state of the operator in charge to “not uttered” (step S219).

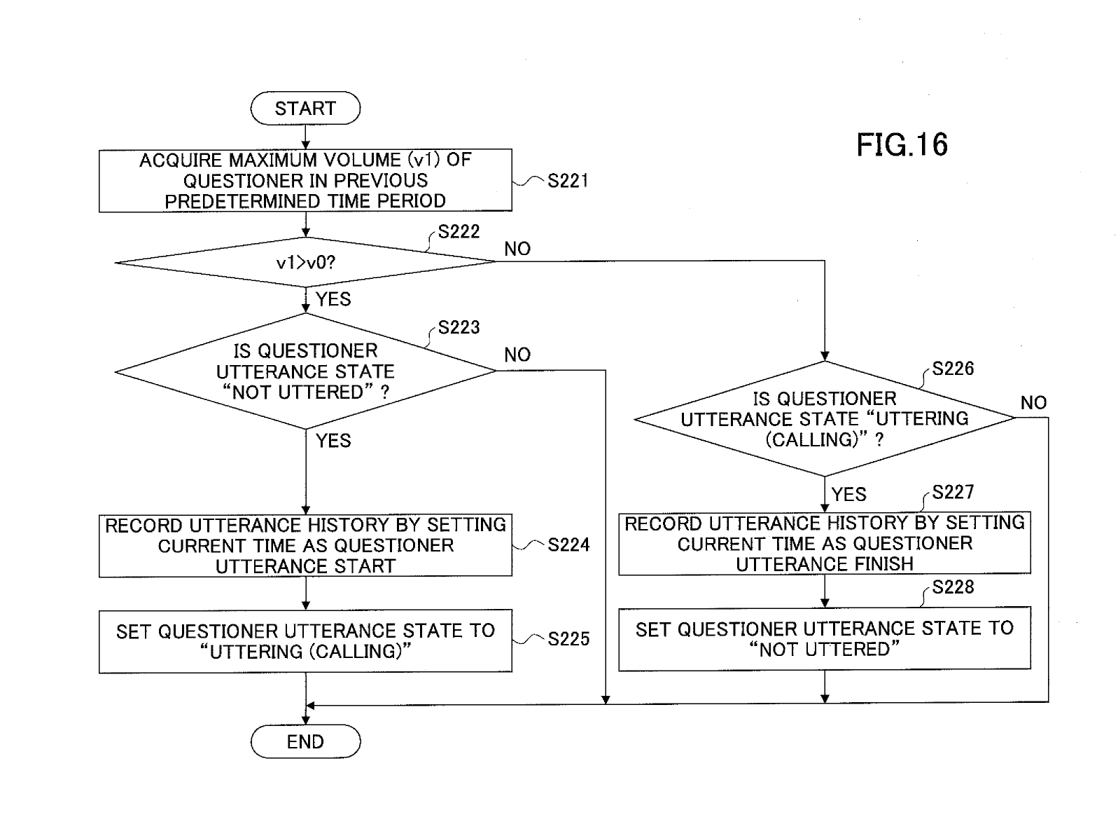

Next, a process in step S206 of FIG. 12 is described. FIG. 16 is a flowchart illustrating an example procedure of checking an utterance state of the questioner. The procedure of FIG. 16 is similar to the procedure of FIG. 14 except that the “operator” is replaced by the “questioner”.

Therefore, the descriptions of the procedure in FIG. 16 are obvious based on the descriptions of the procedure in FIG. 14 and are herein omitted. However, in the procedure of FIG. 16, it is not necessary to perform the process of step S215 (in which the time period of the operator utterance is associated with the identifier of the manual page).

Next, a process is described in which the manager checks the initial evaluation value of a specific call, and corrects the initial evaluation value.

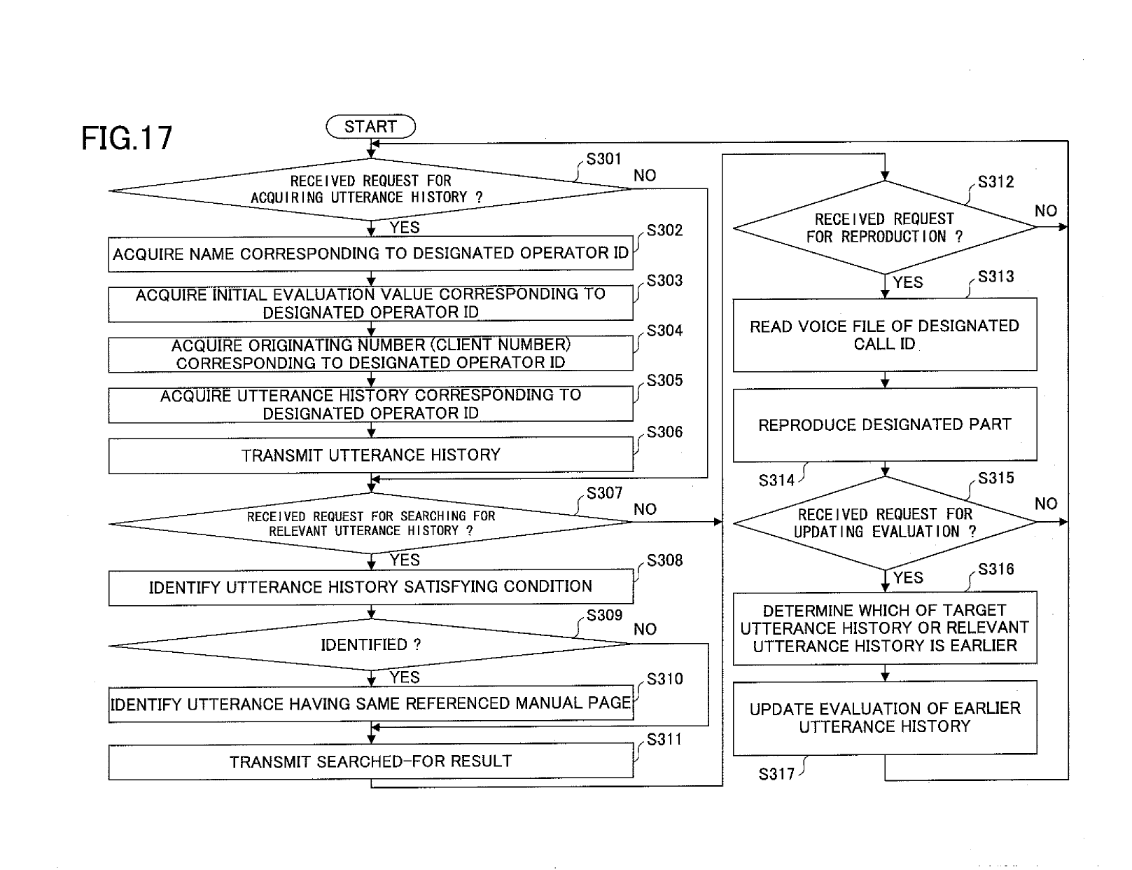

In the manager terminal 30, when the manager designates the operator ID and inputs a display instruction to display the utterance history, the utterance history acquirer 32 sends a request for acquiring the utterance history (acquisition request) to the call management apparatus 10. In response to the acquisition request, the call management apparatus 10 performs the procedure illustrated in FIG. 17.

FIG. 17 is a flowchart illustrating an example procedure of updating an evaluation value.

When the request for acquiring the utterance history (acquisition request) is received in the call management apparatus 10 (Yes in step S301), the designated utterance history acquirer 127 acquires a name (full name) of the operator corresponding to the operator ID designated in the acquisition request (hereinafter “designated operator ID”) from the operator data storage 141 (step S302). Further, the acquisition request may designate not the operator ID but the name of the operator. In this case, the operator ID corresponding to the name may be acquired from the operator data storage 141.

Next, the designated utterance history acquirer 127 acquires the initial evaluation value of the designated operator ID from the evaluation data storage 147 (FIG. 11) (step S303). The initial evaluation value of the designated operator ID refers to the initial evaluation value related to the telephone call corresponding to the operator related to the designated operator ID (hereinafter “designated operator”). The telephone call refers to the telephone call related to the call ID of the record including the operator ID in the response history storage 146 (hereinafter “designated call ID”).

Therefore, in the evaluation data storage 147, the initial evaluation value recorded for the designated call ID is the initial evaluation value corresponding to the designated operator ID. Further, typically, each operator handles a plurality telephone calls in one day. Therefore, in the response history storage 146, there may exist a plurality of records in which the designated operator ID is recorded (i.e., the designated call ID).

Accordingly, a plurality of initial evaluation values corresponding to the designated operator ID may be acquired. However, the initial evaluation values to be acquired here are limited to the initial evaluation values corresponding to the designated call ID where no re-evaluation values are recorded.

After applying such limitation, when there are a plurality of initial evaluation values, all the initial evaluation values may be acquired. Otherwise, for example, the initial evaluation values may be arranged in the increasing or decreasing order based on time when the telephone calls corresponding to the initial evaluation values are received, and only the first initial value may be acquired.

Otherwise, in the request for acquiring the utterance history, the call ID or time period may be designated (identified). When the time period is designated, in the response history storage 146, the initial value corresponding to the call ID of the record which is received in the designated time period may be acquired. Hereinafter, the call ID relevant to the acquired initial evaluation value is called a “target call ID”.

Next, the designated utterance history acquirer 127 acquires the originating number (or client number) relevant to the target call ID from the response history storage 146 (FIG. 8) (step S304).

Next, the designated utterance history acquirer 127 acquires the utterance history table 142T relevant to the target call ID from the utterance data storage 142 (step S305).

Next, the history output unit 129 transmits (outputs) a response to the manager terminal 30, the response including the name of the designated operator, the initial evaluation value relevant to the target call ID, the originating number, and the storage contents of the utterance history table 142T (i.e., utterance history) (step S306).

The response may further include, for example, a plurality of initial values and a plurality of utterance histories related to a plurality of telephone calls handled by the designated operator.

In the manager terminal 30, when the response is received, the utterance history screen generator 33 generates an utterance history screen which displays the utterance history included in the response. The input/output controller 31 of the manager terminal 30 displays the utterance history screen on the display device of the manager terminal 30.

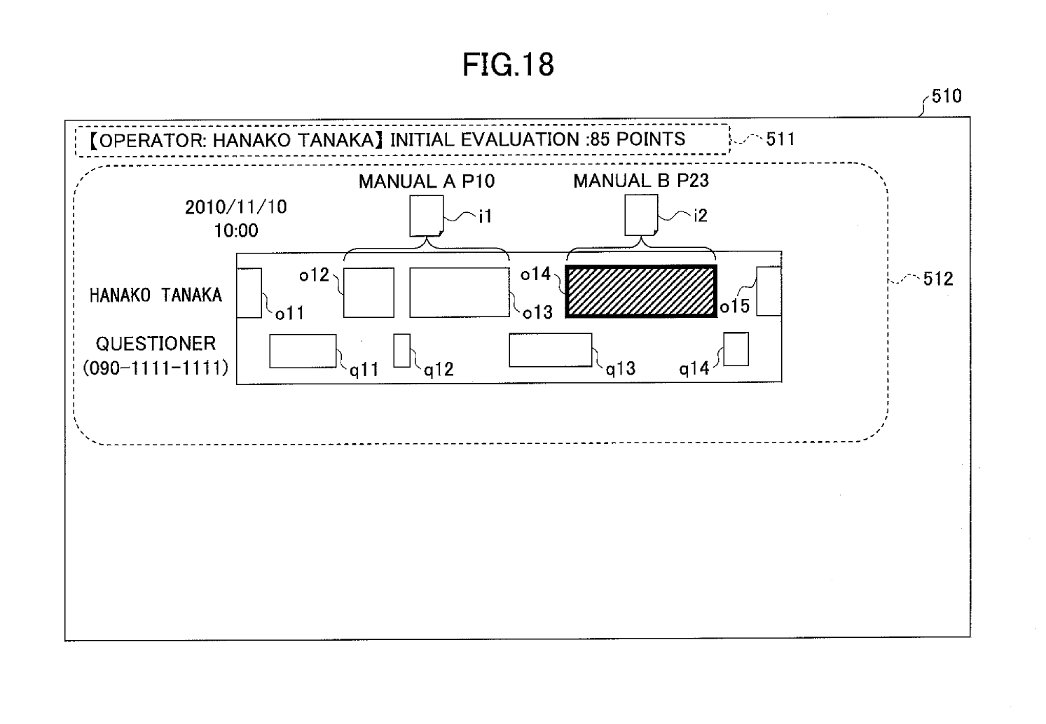

FIG. 18 illustrates an example display of the utterance history screen 510. As illustrated in FIG. 18, the utterance history screen 510 includes an evaluation value display area 511 and an utterance history display area 512.

The evaluation value display area 511 displays a name of the operator and the initial evaluation value. The utterance history display area 512 displays the operator utterance and the questioner utterance in a rectangular manner. The rectangles o11 through o15 denote the operator utterances.

The rectangles q11 through q14 denote the questioner utterances. The width in the horizontal direction denotes the time period of the utterance. In the utterance history, the rectangle corresponding to the operator utterance which is associated with the identifier of the manual page (manual name and page number) displays an icon indicating the page of the manual (manual page) and the corresponding (associated) manual name and the page number.

For example, the rectangles o12 and o13 are associated with the manual name and the page number which are “manual page A P10” and the icon “i1” indicating the manual page. Also, the rectangle o14 is associated with the manual name and the page number which are “manual page B P23” and the icon “i2” indicating the manual page.

Further, when the utterance history and the like, which corresponds to a plurality of telephone calls which is handled by the designated operator, are received, the utterance history screen 510 may be generated so as to display the utterance histories on the respective sheets which may be switched (selected) to be displayed using tabs or the like.

For example, when the manager selects any one of the rectangles corresponding to the operator utterance, the utterance history acquirer 32 of the manager terminal 30 sends a request for acquiring the relevant utterance history to the call management apparatus 10. Here, the “relevant utterance history” refers to the utterance history having a relationship with one utterance history which currently is to be displayed in the utterance history screen 510 (hereinafter “target utterance history”), the relationship being obtained when a relevant condition stored in the relevant condition storage 148 is satisfied.

In the request for acquiring the relevant utterance history, the call ID relevant to the target utterance history and the manual name and the page number associated with the selected rectangle are designated. In the example of FIG. 18, the value “0001” is designated as the call ID. Further, for example, when the rectangle o14 is selected, “manual page A” and “P10” are designated as the manual name and the page number.

In the call management apparatus 10, when the request for acquiring the relevant utterance history is received (Yes in step 307), the relevant utterance history identification unit 128 identifies the utterance history which satisfies the relevant condition stored in the relevant condition storage 148 (step S308).

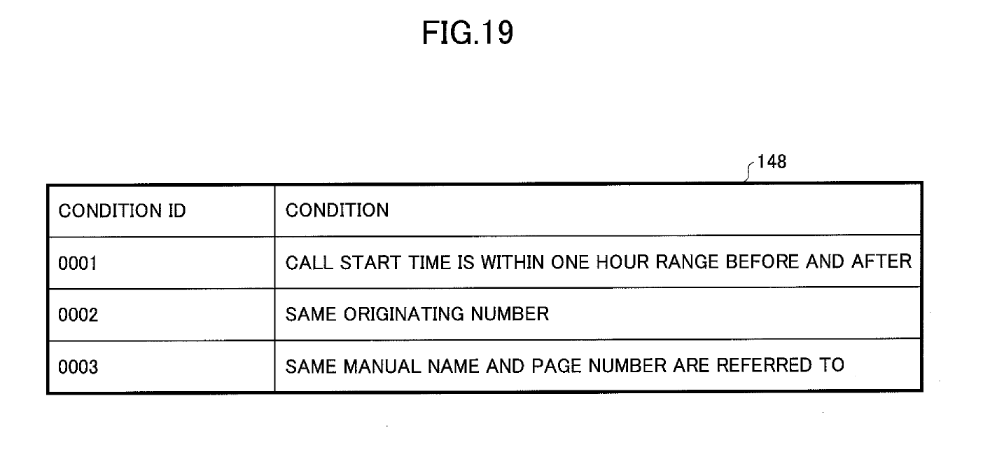

FIG. 19 is a drawing illustrating an example configuration of a relevant condition storage 148. As illustrated in FIG. 19, the relevant condition storage 148 includes an item “condition”. Further, a condition ID is assigned to each condition. However, the condition ID may not be assigned. In FIG. 19, three conditions are described.

The first condition is that the utterance start time is within one hour before and after (a reference time). The second condition is that the same originating number is referred to. The third condition is that the same manual name and page number are referred to. Those conditions are for estimating the same question. Namely, an operator is more likely to refer to the same manual page to respond to the same question.

Therefore, if the same manual page is referred to, it is highly likely that the same question is asked. Further, in this embodiment, the logical AND (AND relationship) among the three conditions is regarded as the relevant condition.

The relevant utterance history identification unit 128 identified the relevant utterance history having the relationship with the target utterance history where the relevant condition is satisfied between the relevant utterance history and the target utterance history based, for example, as follows.

First, the relevant utterance history identification unit 128 acquires the originating number from the response history storage 146, the originating number being associated with the call ID designated in the request for acquiring the relevant utterance history. Next, the relevant utterance history identification unit 128 acquires a call ID from the response history storage 146, the call ID being associated with the acquired originating number and being the call ID other than the call ID which is designated in the request for acquiring the relevant utterance history.

Namely, the call ID is acquired which has the same originating number as that of the call ID designated in the request for acquiring the relevant utterance history. When acquiring the call ID, the relevant utterance history identification unit 128 further acquires the utterance history table 142T corresponding to the acquired call ID from the utterance data storage 142.

Hereinafter, the utterance history relevant to the acquired utterance history table 142T is called a “candidate history”. Next, the relevant utterance history identification unit 128 searches for the utterance history table 142T from the utterance data storage 142, the utterance history table 142T corresponding to the call ID other than the call ID designated in the request for acquiring the relevant utterance history.

Based on the searched-for utterance history table 142T, the relevant utterance history identification unit 128 identifies the start time and finish time of the target utterance history. Next, the relevant utterance history identification unit 128 extracts the candidate history having a calling time interval which, for example, overlaps a time interval which starts from the identified finish time and ends one hour later from the identified finish time or a time interval which starts one hour earlier than the identified start time to the identified start time.

Next, the relevant utterance history identification unit 128 identifies the candidate history, as the relevant utterance history, including the manual name and page number corresponding to the manual name and page number included in the target utterance history from among the extracted candidate histories.

Based on the relevant condition, the utterance history is identified that is related to a call which corresponds to the call from the same questioner, which is conducted within one hour before and after, and in which it is desired to refer to the same manual page.

If the relevant utterance history which satisfies the relevant condition is later than the target utterance history in terms of time, it is estimated that the response by the operator related to the target utterance history is insufficient. This is because the questioner may not sufficiently understand on the first call, and calls the second time to ask the same question again.

On the other hand, if the relevant utterance history which satisfies the relevant condition is earlier than the target utterance history in terms of time, similarly, it is also estimated that the response by the operator related to the relevant utterance history is insufficient.

Further, the first condition “within one hour before and after” of the relevant condition is an example only. Namely, for example, a condition that identifies that the call is conducted within a specific time range before and after the reference time may be used.

As the time point which is the reference time for the condition “within a specific time before and after (the reference time)”, any time point between the start and finish time of the target utterance history may be used. Further, the time point included in the time period from the start time to the finished time may be used as the first condition.

However, some questioner may ask the same question after several days. Therefore, the first condition may not be used. However, as in this embodiment, by setting the first condition “within a predetermined time”, it may be possible to distinguish a case where the questioner is unable to understand the answer from a case where the questioner forgets the response contents.

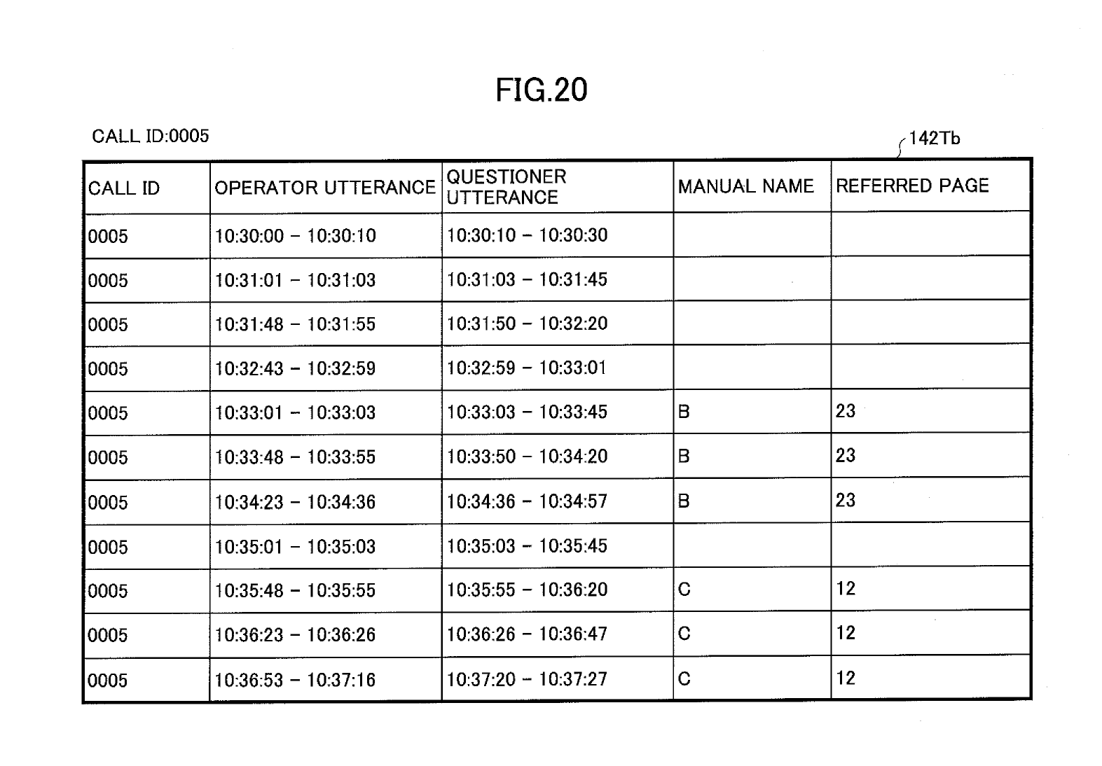

For example, in a case where the utterance history illustrated in the utterance history table 142Ta of FIG. 15 is the target utterance history, as one example of the relevant utterance history which satisfies the relevant condition, there is the utterance history illustrated in the utterance history table 142Tb of FIG. 20.

FIG. 20 illustrates an example of relevant utterance history. In the utterance history illustrated in the utterance history table 142Tb of FIG. 20, similar to the utterance history in the utterance history table 142Ta, the manual page of the manual name “B” and the page number “23” is referred to.

Further, the start time of the utterance history in the utterance history table 142Tb is 10:30, which is within one hour from any time point (e.g., start time) between the start and finish time of the utterance history in the utterance history table 142Tb. Further, it is assumed that the utterance history table 142Ta and the utterance history table 142Tb are the utterance histories relevant to the same originating number.

When there is no relevant utterance history (No in step S309), the history output unit 129 transmits the searched-for result indicating that there is no relevant utterance history to the manager terminal 30 (step S300).

On the other hand, when relevant utterance history is identified, in the relevant utterance history, the relevant utterance history identification unit 128 identifies the operator utterance related to the time period associated with the manual name and page number designated in the request for acquiring the relevant utterance history (hereinafter “relevant utterance”) (step S310). For example, the data indicating the relevant utterance (e.g., flag data) are associated with the identified operator utterance.

Next, the relevant utterance history identification unit 128 transmits the response including the relevant utterance history to the manager terminal 30 (step S311).

When the manager terminal 30 receives the response, the utterance history screen generator 33 of the manager terminal 30 generates a pop-up screen to display the relevant utterance history included in the response. The input/output controller 31 of the manager terminal 30 causes the display device of the manager terminal 30 to display the pop-up screen.

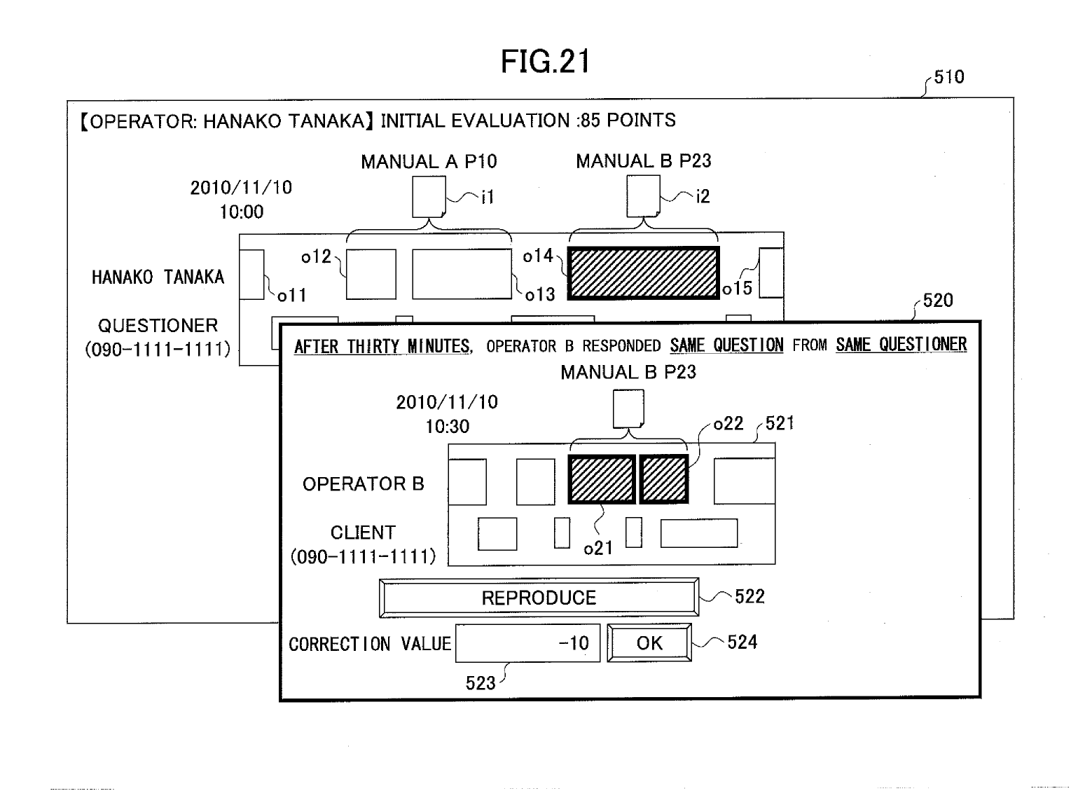

FIG. 21 illustrates an example display of the pop-up screen displaying the relevant utterance history. As illustrated in FIG. 21, the pop-up screen 520 is displayed in a manner that the pop-up screen 520 overlaps the utterance history screen 510. Further, the pop-up screen 520 includes a relevant utterance display area 521, a reproduce button 522, a correction value input area 523, and an OK button 524.

Similar to a format of the utterance history display area 512 of the utterance history screen 510, in the relevant utterance display area 521, the operator utterances and the questioner utterances in the relevant utterance history are displayed as the respective rectangles. Further, in the relevant utterance display area 521, the rectangles o21 and o22 corresponding to the relevant utterance are highlighted to indicate that these correspond to the relevant utterance.

This highlight display includes hatching. Further, the rectangles o21 and o22 are associated with the manual name and page number which are the same as those associated with the rectangle o14 in the utterance history screen 510. Based on the displayed contents, the manager may recognize that the rectangles o21 and o22 correspond to the relevant utterance. Therefore, the manager may recognize the position in time of the relevant utterance in the voice data of the telephone call related to the relevant utterance history.

To clarify the position in time, the start and finish time of the relevant utterance may further be displayed. Further, the utterance history screen generator 33 identifies the rectangle that is to be highlighted based on, for example, the flag data which are associated with the relevant utterance.

The reproduce button 522 is used to receive an instruction to reproduce the utterance contents related to the rectangle selected in the relevant utterance display area 521. The correction value input area 523 is an area to accept the correction value input related to the corresponding initial evaluation value.

The OK button 524 is used to accept an instruction to apply the correction value. Further, a target to which the correction value is applied may differ depending on a positional relationship in time between the relevant utterance history and the target utterance history. Namely, as illustrated in FIG. 21, in case where the relevant utterance history is later, the target to which the correction value is applied is the telephone call related to the target utterance history.

On the other hand, in case where the target utterance history is later, the target to which the correction value is applied is the telephone call related to the relevant utterance history.

For example, when the manager selects the rectangle o21 or o22 and presses the reproduce button 522, the reproduce controller 34 sends a request for reproducing the utterance to the call management apparatus 10 by designating the call ID related to the relevant utterance history, an utterer (operator or questioner) corresponding to the selected rectangle, and time period of the utterance corresponding to the selected rectangle.

When the call management apparatus 10 receives the request for reproducing the utterance (Yes in step S312), the reproducer 130 reads the voice file corresponding to the call ID designated in the request for reproducing (step S313). The voice file may be identified in the voice data management table 143T (FIG. 13) based on the voice file names which are associated with the call ID.

Next, the reproducer 130 reproduces the part, in the voice file, corresponding to the time period designated in the request for reproducing (step S314). In this case, only the channel, which corresponds to the utterer designated in the request for reproducing, may be reproduced. The reproduced voice data are transmitted to the manager terminal 30.

The reproduce controller 34 of the manager terminal 30 outputs the transmitted voice data from a speaker of the manager terminal 30. Therefore, the manager may check the contents of the relevant utterance. As a result, based on the contents of the relevant utterance, the manager may check and evaluate the actual call contents relevant to the call of the target utterance history or the call of the relevant utterance history and the response done by the operator in charge.

For example, the manager may check whether the question asked in the telephone call of the relevant utterance history is the same as the question which is asked before. Further, based on settings, the reproduced part may be limited to the relevant utterance. Therefore, the actual call contents may be efficiently checked.

Further, each utterance displayed in the evaluation value display area 511 of the utterance history screen 510 may be reproduced in the same manner. By doing this, the manager may listen to both the call of the target utterance history and the call of the relevant utterance history to compare those calls.

As a result of the reproduction of the relevant utterance, if the manager determines that it is desired to correct the initial evaluation value, the manager may input the correction value in the correction value input area 523 and pressed the OK button 524.

In response to the pushed OK button 524, the evaluation update requester 35 of the manager terminal 30 sends a request for updating the evaluation value to the call management apparatus 10. In the request for updating the evaluation value, the call ID related to the target utterance history, the call ID related to the relevant utterance history, the input correction value and the like are designated.

When the call management apparatus 10 receives the request for updating the evaluation value (Yes in step S315), the evaluation updater 131 determines which of the target utterance history and the relevant utterance history is earlier (step S316). The determination may be made based on the time data indicating when the calls corresponding call IDs stored in the response history storage 146 are received.

Next, the evaluation updater 131 records the call ID relevant to the utterance history which is determined earlier into the evaluation data storage 147 (FIG. 11) (step S317). Namely, a result, in which the correction value is applied to the initial evaluation value corresponding to the call ID in the evaluation data storage 147, is recorded as the re-evaluation value of the call ID.

Further, not the correction value but the re-evaluation value may be directly input in the pop-up screen 520. In this case, the input value may directly be recorded in the evaluation data storage 147.

In this embodiment, the target utterance history is earlier and the correction value is “−10”. Therefore, the correction value “−10” is applied to the initial evaluation value “85” corresponding to the call ID “0001”. As a result, the re-evaluation value “75” is recorded.

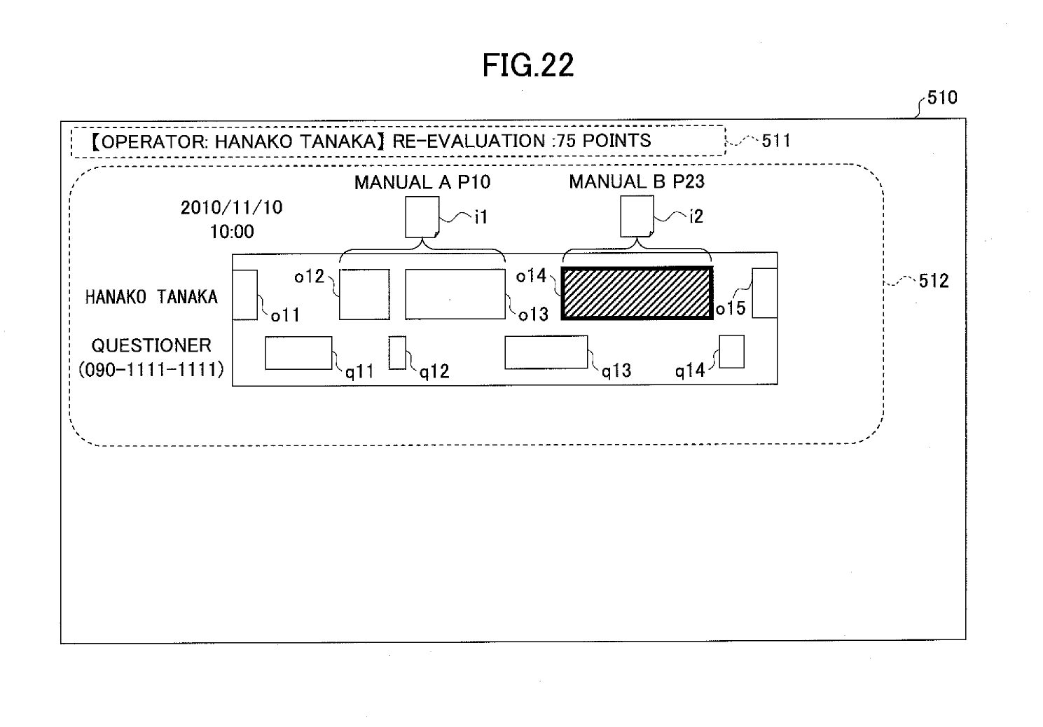

Further, the re-evaluation value may be transmitted from the call management apparatus 10 to be reflected on the utterance history screen 510. FIG. 22 illustrates an example display of the utterance history screen on which a re-evaluation value is reflected. In FIG. 22, the same reference numerals are used to describe the same elements.

The evaluation value display area 511 of the utterance history screen 510 displays the re-evaluation value.

Further, in the above description, a case is described where a target initial evaluation value to be updated is fixed (limited) to the call related to the utterance history which is determined earlier. However, any initial evaluation value related to any of the calls may be updated. This is because it is thought that there may be case where the initial evaluation value related to the call which is later may be unreasonably set lower.

For example, there may be a case where a questioner, who has called before, calls again and tries to fully understand as much as possible. As a result, the questioner does not hang up for a while, so that the time period of the second call becomes longer. In this case, if it is determined that the longer the time period of the call becomes, the lower the initial evaluation value becomes, the initial evaluation value of the second call related to the same question may be unreasonably lower.

In consideration of such a case, for example, an input area where the re-evaluation value can be input may be formed in the utterance history screen 510. If the re-evaluation value is input in the utterance history screen 510, the evaluation update requester 35 of the manager terminal 30 may send the request for updating the evaluation value by designating the call ID related to the target utterance history.

Similarly, tf the re-evaluation value is input in the pop-up screen 520, the evaluation update requester 35 of the manager terminal 30 may send the request for updating the evaluation value by designating the call ID related to the relevant utterance history. The evaluation updater 131 of the call management apparatus 10 may record the re-evaluation value corresponding to the call ID which is designated in the request for updating the evaluation value.

As described above, the call management apparatus 10 according to an embodiment identifies the calls which are relevant to the same question from the same questioner, and outputs data (e.g., utterance history, voice data and the like) which are relevant to the identified calls.

Therefore, the manager may consider the existences of the plurality of calls relevant to the same question from the same questioner, and evaluate the quality of the calls. As a result, it may become possible to improve the accuracy of the evaluation (value) when compared with a case where the calls are independently (separately) evaluated.

Further, in this embodiment, a case is described where the call to be re-evaluated is selected by the manager and the utterance history, which has the relationship with the call where the relevant condition is satisfied therebetween, is identified. However, for example, a pair of calls, in which the relevant condition is satisfied, may be selected in a batch manner.

For example, when the task of the day is terminated, the process of steps S302 through S311 of FIG. 17 may be performed on the call ID of the records included in the response history storage 146 in a batch matter, so that a list including pairs of utterance histories, in which the relevant condition is satisfied therebetween, is transmitted to the manager terminal 30.

Further, the data, which is used to check the commonality between the calls to determine the identity of the question between the calls, is not limited to the manual page which is referred to. Any appropriate data may be used, which may be used by the operators to be referred to, to respond to the questions and which include many parts to be referred to that differ depending on the questions. For example, the identity of the question between the calls may be estimated based on the commonality of the Frequently-Asked-Question (FAQ) data.

Further, in this embodiment, the relevant utterance history identification unit 128 is an example of the “identification unit”. The history output unit 129 is an example of the “output unit”. Further, the auxiliary storage device 102 is an example of the “storage”.

As described above, an embodiment of the present invention is disclosed. However, the present invention is not limited to the specific embodiment, and various modifications and changes may be made without departing from the scope of the present invention.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention.

Although the embodiment of the present invention has been described in detail, it should be understood that various changes, substitutions, and alterations could be made hereto without departing from the spirit and scope of the invention.

According to an embodiment, it may become possible to support improving the accuracy of the evaluation of the call contents in a call center.

What is claimed is:

1. A call management apparatus comprising:
a storage configured to store a questioner identifier in association with a reference data identifier for a call performed between a questioner and an operator who responds to the questioner, the questioner identifier identifying the questioner and the reference data identifier identifying reference data that are displayed on an operator terminal used by the operator during the call and that are used when the operator responds to the questioner;
an identification unit configured to refer to the storage, identify the questioner identifier and the reference data identifier that are associated with a first call, and identify a second call that is different from the first call and associated with the same questioner identifier and the same reference data identifier associated with the first call; and
an output unit configured to output first data related to the first call and second data related to the second call.

2. The call management apparatus according to claim 1,
wherein the storage is configured to store the call in association with date and time data indicating date and time when the call is performed, and
wherein the identification unit is configured to refer to the storage and identify the second call that is associated with second date and time data that are within a predetermined range from first date and time data associated with the first call in the storage.

3. The call management apparatus according to claim 1,
wherein the storage is configured to store the reference data identifier in association with time data indicating time when the reference data are referred to for each call, and
wherein the output unit is configured to output first time data stored in association with the first call in the storage and second time data stored in association with the second call in the storage based on the reference data identifier that is associated with both the first call and the second call.

4. The call management apparatus according to claim 3,
wherein the storage is configured to store voice data for each call, and
wherein the call management apparatus further comprises:
a reproducer configured to reproduce a part of the voice data of the first call that is related to the first time data or a part of the voice data of the second call that is related to the second time data.

5. A method of managing calls comprising:
referring to, by a computer, a storage that stores a questioner identifier in association with a reference data identifier for a call performed between a questioner and an operator who responds to the questioner, the questioner identifier identifying the questioner and the reference data identifier identifying reference data that are displayed on an operator terminal used by the operator during the call and that are used when the operator responds to the questioner;
identifying, by the computer, the questioner identifier and the reference data identifier that are associated with a first call;
identifying, by the computer, a second call that is different from the first call and associated with the same questioner identifier and the same reference data identifier associated with the first call; and
outputting, by the computer, first data related to the first call and second data related to the second call.

6. The method according to claim 5, further comprising:
referring to, by the computer, the storage that stores the call in association with date and time data indicating date and time when the call is performed; and
identifying, by the computer, the second call that is associated with second date and time data that are within a predetermined range from first date and time data associated with the first call in the storage.

7. The method according to claim 5, further comprising:
referring to, by the computer, the storage that stores the reference data identifier in association with time data indicating time when the reference data are referred to for each call; and
outputting, by the computer, first time data stored in association with the first call in the storage and second time data stored in association with the second call in the storage based on the reference data identifier that is associated with both the first call and the second call.

8. The method of managing calls according to claim 7, further comprising:
referring to, by the computer, the storage that stores voice data for each call; and
reproducing, by the computer, a part of the voice data of the first call that is related to the first time data, or a part of the voice data of the second call that is related to the second time data.

9. A computer-readable recording medium having stored therein a program for causing a digital processing computer to execute a process comprising:
referring to a storage that stores a questioner identifier in association with a reference data identifier for a call performed between a questioner and an operator who responds to the questioner, the questioner identifier identifying the questioner and the reference data identifier identifying reference data that are displayed on an operator terminal used by the operator during the call and used when the operator responds to the questioner;
identifying the questioner identifier and the reference data identifier associated with a first call;
identifying a second call that is different from the first call and associated with the same questioner identifier and the same reference data identifier associated with the first call; and
outputting first data related to the first call and second data related to the second call.

10. The computer-readable recording medium according to claim 9 further comprising:
referring to the storage that stores the call in association with date and time data indicating date and time when the call is performed; and
identifying the second call associated with second date and time data that are within a predetermined range from first date and time data associated with the first call in the storage.

11. The computer-readable recording medium according to claim 9, further comprising:
referring to the storage that stores the reference data identifier in association with time data indicating time when the reference data are referred to for each call; and
outputting first time data stored in association with the first call in the storage and second time data stored in association with the second call in the storage based on the reference data identifier that is associated with both the first call and the second call.

12. The computer-readable recording medium according to claim 11, further comprising:
referring to the storage that stores voice data for each call; and
reproducing a part of the voice data of the first call that is related to the first time data or a part of the voice data of the second call that is related to the second time data.
